(19) United States
(12) Patent Application Publication
(10) Pub. No.: US 2016/0171401 A1
(43) Pub. Date: Jun. 16, 2016

(54) LAYOUT OPTIMIZATION FOR INTERACTIONAL OBJECTS IN A CONSTRAINED GEOGRAPHICAL AREA

(71) Applicants: Hao Wu, Shanghai (CN); Yu Cheng, Shanghai (CN); Wen-Syan Li, Fremont, CA (US)

(72) Inventors: Hao Wu, Shanghai (CN); Yu Cheng, Shanghai (CN); Wen-Syan Li, Fremont, CA (US)

(21) Appl. No.: 14/567,458

(22) Filed: Dec. 11, 2014

(51) Int. Cl. G06Q 10/06

(52) U.S. Cl. CPC G06Q 10/06312; G06Q 10/06315

(57) ABSTRACT

The present disclosure describes methods, systems, and computer program products for finding a best location scheme for a set of interactional objects in a constrained geographical area. A geographic region representing a wind farm is partitioned into a plurality of lattices. Initial chromosomes are generated, where a particular chromosome is a binary series used to represent the presence of a wind turbine in a layout of the plurality of lattices. A cost associated with each wind turbine associated with the initial chromosomes is evaluated. Parent chromosomes are selected for a genetic operation, and following the genetic operation, a cost associated with each wind turbine if evaluated. The parent chromosomes are updated using a fitness value.

### BACKGROUND

Layout optimization is the process of finding a best location scheme for a set of interactional objects in a constrained geographical area. Generally, each interactional object is affected by other nearby objects in terms of benefit and cost to the whole system, and the optimized layout can maximize the overall benefit and minimize the overall cost. Since the optimized location of one interactional object can be dependent on all of the other interactional objects, a solution to a layout optimization problem is not trivial. The lack of an ability to accurately solve layout optimization problems can results in, among other things, inefficiency in a system to be optimized, loss of revenue, a loss of marketing, sales, and/or business opportunities, and/or a failure of the system.

### SUMMARY

The present disclosure relates to computer-implemented methods, computer-readable media, and computer systems for finding a best location scheme for a set of interactional objects in a constrained geographical area. A geographic region representing a wind farm is partitioned into a plurality of lattices. Initial chromosomes are generated, where a particular chromosome is a binary series used to represent the presence of a wind turbine in a layout of the plurality of lattices. A cost associated with each wind turbine associated with the initial chromosomes is evaluated. Parent chromosomes are selected for a genetic operation, and following the genetic operation, a cost associated with each wind turbine if evaluated. The parent chromosomes are updated using a fitness value.

One computer-implemented method includes partitioning, a geographic region representing a wind farm into a plurality of lattices, generating initial chromosomes, wherein a particular chromosome is a binary series used to represent the presence of a wind turbine in a layout of the plurality of lattices, evaluating a cost associated with each wind turbine associated with the initial chromosomes, selecting parent chromosomes for a genetic operation, evaluating, following the genetic operation, a cost associated with each wind turbine, and updating the parent chromosomes using a fitness value.

Other implementations can include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein the genetic operation includes at least one of a crossover or mutation operation.

A second aspect, combinable with any of the previous aspects, comprising determining whether a generated value has met a maximum threshold value.

A third aspect, combinable with any of the previous aspects, establishing a candidate pool of feasible lattices associated with a wind farm, randomly selecting a lattice within the pool of feasible lattices, installing a wind turbine on the selected lattice, calculating a wind effect from the selected lattice, updating wind speed associated with neighboring lattices, removing the selected lattice from the candidate pool, and ranking wind speed of lattices in the candidate pool.

A fourth aspect, combinable with any of the previous aspects, comprising determining whether multiple lattices in the candidate pool have identical largest wind speeds.

A fifth aspect, combinable with any of the previous aspects, comprising determining and selecting a best lattice from among the multiple lattices in the candidate pool with identical largest wind speeds or selecting at random a best lattice from among the multiple lattices in the candidate pool with identical largest wind speeds.

A sixth aspect, combinable with any of the previous aspects, comprising updating the selected lattice with a wind turbine.

The subject matter described in this specification can be implemented in particular implementations so as to realize one or more of the following advantages. First, instead of approximating wind farm construction and maintenance costs relative to a particular number of wind turbines, specific values for factors (e.g., road construction, geographic constraints, etc.) are considered on a case-by-case basis. Second, a greedy initialization approach is proposed, which improves efficiency of a genetic algorithm (GA) and provides several good initial solutions with little time cost. Third, an optimal road construction methods/cost is proposed according to a given layout of wind turbines and existing public roads. This proposal permits evaluation of a wind farm layout with respect to specific wind farm conditions, factors, situations, etc. Fourth, setback constraints for prohibited areas are considered to help mitigate effects of the prohibited areas. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is an illustration of an example wind farm according to an implementation.

FIG. 2A illustrates an example of a windy site partitioned into a lattice according to an implementation.

FIG. 2B illustrates an example of a windy site according to an implementation.

FIG. 3 is a high-level architecture block diagram illustrating an example distributed computing system (EDCS) for finding a best location scheme for of a set of interactional objects in a constrained geographical area according to an implementation.

FIG. 4 illustrates an example of a wake effect according to an implementation.

FIG. 5 is an illustration of an example windy site according to an implementation.

FIG. 6A illustrates an example of a generated planar graph (i.e., a road network, in the windy site illustrated in FIG. 5) according to an implementation.

FIG. 6B illustrates an example of a calculated [symbol] given the road network shown in FIG. 6A according to an implementation.

FIG. 7 is a flow chart illustrating a genetic algorithm for finding a best location scheme for of a set of interactional objects in a constrained geographical area according to an implementation.

FIG. 8 illustrates an example of an encoded chromosome according to an implementation.

FIG. 9 is a flow chart illustrating an alternative example genetic algorithm to find a best location scheme for a set of interactional objects in a constrained geographical area according to an implementation.

FIG. 10A illustrates an example of a crossover operation according to an implementation.

FIG. 10B illustrates an example of a mutation operation according to an implementation.

FIG. 11 is a block diagram of an exemplary computer used in the EDCS of FIG. 3 according to an implementation.

Like reference numbers and designations in the various drawings indicate like elements.

### DETAILED DESCRIPTION

The following detailed description is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

Layout optimization is the process of finding a best location scheme for of a set of interactional objects in a constrained geographical area. Generally, each interactional object is affected by other nearby objects in terms of benefit and cost to the whole system, and the optimized layout can maximize the overall benefit and minimize the overall cost. Since the optimized location of one interactional object can be dependent on all of the others interactional objects, a solution to a layout optimization problem is not trivial.

As will be understood by those of ordinary skill in the art, there are several real-world applications of this problem, such as layout designs of integrated circuits, placement of power generation units (e.g., such as wind turbines and tide turbines) in power plants, and/or distribution plans of sensor networks. While the following description focuses on wind farm layout optimization, wind power generation, and related interactional objects, computer-implemented methods, computer-readable media, and computer systems, the description is intended only to illustrate and enhance understanding of described concepts and is not meant to limit application of the described concepts to only the described example. Those of ordinary skill will understand modifications to at least the described systems and methods that are necessary to generalize the described concepts for applicability for other applications.

Wind energy has become one of the most important and fast-growing sources of renewable energy. Transformation of wind power into electrical power is performed by wind turbines, which are usually clustered together in a wind farm within a certain geographic region, called a “windy site.” To obtain wind energy efficiently, a wind farm layout optimization problem to optimize the layout of wind turbines in the windy site is an important phase of the wind farm's design. Several factors must be considered simultaneously during the optimization process, such as the cost of turbine installation, the cost of road building, the cost of maintenance, and the efficiency of overall electricity production. We call this problem the.

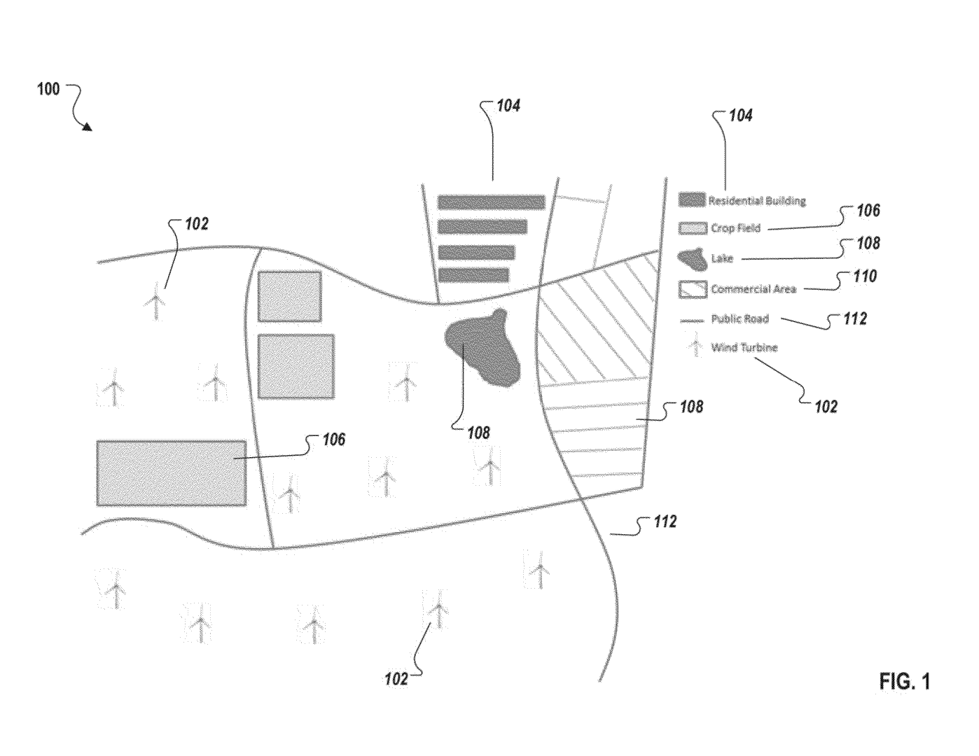

FIG. 1 is an illustration of an example wind farm 100 according to an implementation. Each wind turbine 102 is expected to work efficiently with maximized power output. However, as the number of wind turbines 102 increases, a large wind farm faces a potential power loss caused by wind-turbine-generated turbulence (a wake effect) that propagates downwind through the wind farm and affects other wind turbines 102. In a wake area, wind speed and generated electrical power are reduced. In this example, another difficulty for the wind farm are various prohibited areas, such as residential buildings 104, crop fields 106, bodies of water (e.g., lake) 108, and commercial areas 110 that are interspersed around and within the wind farm geographic area. To maximize efficiency, wind turbines 102 should not be placed in or close to such prohibited area to prevent, for example, annoyance of local residents, commercial activities, etc. Roads (here public) 112 also exist in the example in the wind farm 100. Roads (public and/or private) should be connected to each wind turbine 102 to allow for installation, maintenance, and/or other purposes. The cost of road construction is sought to be minimized but deemed necessary to have a complete network of roads connecting aspects of the wind farm 100.

A genetic algorithm (GA) has traditionally been used to solve the wind farm layout optimization problem. However, GA is a population-based method suffering from both delayed result times and requiring a high computational burden during execution. Moreover, wind farm construction and maintenance costs are usually approximately expressed relative to a particular number of wind turbines 102. In actuality, some real-world factors (e.g., road construction, geographic constraints, etc.) are different from case-to-case and should be treated specifically, otherwise a generated optimal solution cannot be guaranteed, even if feasible.

The following detailed description describes various improvements to the use of GA for the wind farm layout optimization problem. First, instead of approximating wind farm construction and maintenance costs relative to a particular number of wind turbines, specific values for factors (e.g., road construction, geographic constraints, etc.) are considered on a case-by-case basis. Second, a greedy initialization approach is proposed, which improves GA efficiency and provides several good initial solutions with little time cost. Third, an optimal road construction method is proposed according to a given layout of wind turbines and existing public roads. This proposal permits evaluation of a wind farm layout with respect to specific wind farm conditions, factors, situations, etc. Fourth, setback constraints for prohibited areas are considered to help mitigate effects of the prohibited areas.

At a high level, a method is described to solve a layout optimization problem, in particular, a wind farm layout optimization problem, with a consideration of road construction costs. A GA approach is also proposed to solve the wind farm layout optimization problem with a good initial status and an adaptive evaluation function for high efficiency.

A GA is an algorithm that simulates the behaviors of genes to find the near-optimal solution for a particular problem. In the natural world, genes can crossover with each other, mutate, or be removed from the population due to its unfitness to the nature. After several generations the best genes may survive from the selection of nature. The process of solving a problem with a GA is similar.

Each potential solution (e.g. a layout of interactional objects over the constrained area) can be regarded as a gene (a.k.a. chromosome, or individual)—for the purposes of this disclosure, it is an array (e.g., of 0's and 1's) indicating the absence and presence of a wind turbine in a specific grid cell.

The algorithm first generates an initial population of genes (i.e. potential solutions) and then enters an iterative cycle to create the best gene (i.e. the optimal solution). In each iteration, a set of most fitting genes (i.e., with the highest fitness scores) are selected, and allowed to crossover with a random gene mate within the group. These crossovers can then generate another group of new genes. This new group of genes is then added to the original population, and those genes that have the lowest fitness scores from the original population are removed. After several rounds of iterations, the best genes (i.e. the optimal solutions) can be determined.

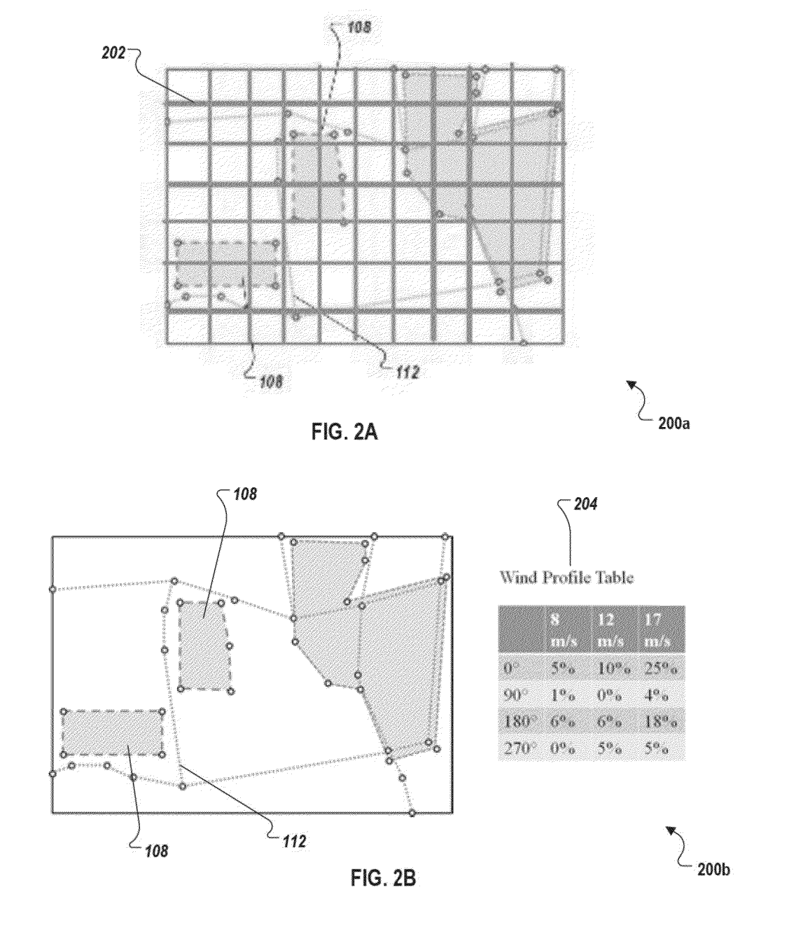

In some implementations, wind farm layout optimization begins by evenly partitioning target land into lattices. Lattices with any prohibited factor are eliminated. FIG. 2A illustrates an example of a windy site 200a partitioned into a lattice 202 according to an implementation. In the illustrated windy site 200a example, there are at least two bodies of water 108 (e.g., prohibited factor) and one road 112 from south to north.

Before a GA is implemented to solve the wind farm layout optimization problem, several potential solutions (i.e., possible layouts of objects) are generated as a part of a group of initial individual solutions for use by the GA. There are many methods for generating an initial population. For the purposes of this disclosure, the typical methods used are fully-random generation and greedy generation. The fully-random method generates each gene (i.e., a solution) fully randomly (i.e., placing n wind turbines randomly in an area to make a possible solution. The greedy generation method generates each gene by placing n wind turbines one-by-one to best locations. In other implementations, as will be appreciated by those of ordinary skill in the art, other methods consistent with this disclosure can be used for generating an initial population. Other methods for generating an initial population are considered to be within the scope of this disclosure.

A particular GA is then implemented to search for the best solution, in which, each individual solution is evaluated with consideration of a wake effect in benefit and an optimal road construction method in cost. For efficiency purposes, a general and simplified cost expression is utilized at the beginning phase of GA fitness evaluation, which is replaced by a proposed cost expression in a latter phase(s) to improve accuracy.

Problem Description

In some implementations, all wind turbines are assumed to be placed on a given windy site [symbol] , where each component is defined as:
[symbol] —The bounding rectangle box of the whole area.
[symbol] —The set of existing roads which can be used for transporting assembling units of wind turbines. Each road in the set is modeled as a curve without widths.
[symbol] —The set of prohibited areas on which a wind turbine cannot be places or road built (e.g., lakes, crop fields, buildings, etc. as illustrated in FIG. 1). In some implementations, each prohibited area is modeled as a polygon.
[symbol] refers to a wind profile of the windy site. An assumption is made that each location in the windy site has identical wind speed and direction at any specific time. With this assumption, the wind profile of the entire site can be modeled simply by a probability distribution of the combinations of wind speed and direction in a year, (e.g., [symbol] [symbol] P(s, d)). In practice, possible values of wind speed and direction can be discretized and the mentioned distribution function converted into a simple table.

FIG. 2B illustrates an example of a windy site 200b according to an implementation. Here, windy site 200b is the same as that illustrated in FIG. 2A without the lattice structure illustration. In the example of FIG. 2B, three possible values of wind speed (8 m/s, 12 m/s, and 17 m/s), and four possible wind directions (0°, 90°, 180°, and 270°) are considered. Wind profile table 204 shows percentages for each wind speed per direction.

A total number (N) of wind turbines 102 is, in some implementations, fixed in advance. A layout of wind turbines 102, denoted by:

[symbol]

={p₁,p₂, . . . ,p_{N}},

is a set of N points, each point corresponding to a wind turbine 102 of all wind turbines 102 placed on the windy site 200b. In some implementations, different layouts of wind turbines can correspond to different expected annual electricity production, denoted by:

Eₜₒₜₐₗ( [symbol] )

as well as different overall costs, denoted by:

Cₜₒₜₐₗ( [symbol] ).

Therefore, the wind farm layout optimization problem is to find a layout ( [symbol] ) on a windy site ( [symbol] ), such that the value of an objective function F( [symbol] ) (i.e., “fitness”):

$$F ( ) = \frac{{E}_{total} ( )}{{C}_{total} ( )} ,$$

is maximized.

System Architecture

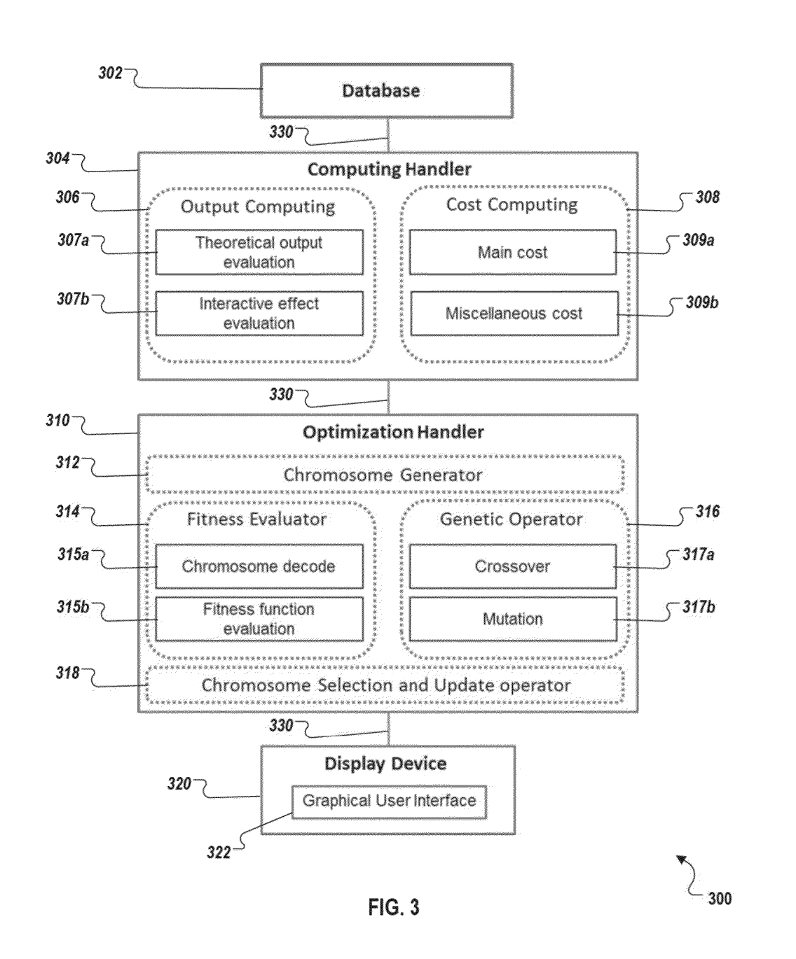

FIG. 3 is a high-level architecture block diagram illustrating an example distributed computing system (EDCS) 300 for finding a best location scheme for of a set of interactional objects in a constrained geographical area according to an implementation. At a high level, the illustrated EDCS 300 includes or is made up of one or more communicably coupled computers (see FIG. Y) that communicate across a network 330. In some implementations, one or more components of the EDCS 300 can operation within/as a part of a cloud-computing-based environment. Although there are only three indicated instances of network 330, one or more other illustrated connections between components of the EDCS 300 can also be considered part of network 330. The illustrated EDCS 300 includes a database 302, a computing handler 304, an optimization handler 310, and a display device 308.

Input Data

In typical implementations, input data is stored in a database 302. In the provided example, the database is a column-store, in-memory database. In other implementations, a row-store and/or conventional database can be used. The input data includes geographic information, wind turbine information and other necessary parameters for electricity output computation.

For example, in some implementations, the geographic information used to describe properties of land in a wind farm 100 can be stored in the database 302 in a separate geographical information database table (Table 1) storing data similar to:

TABLE 1

| Column Name | Description |
|---|---|
| Location | Geographical Coordinate. |
| Label | Characteristics of objective within a location, |
| | e.g., available or prohibited. |
| Wind Profile | Statistical information of wind speed and |
| | direction. |
| Existing Roads | Existing roads that can be used for us to |
| | transport wind turbine components. |
| Entry Point | The location of entering the windy site. |
| Surface Roughness | The terrain characteristic. |

In the example geographical information table, each location in a certain geographical area is labeled by characteristics for a wind farm layout (e.g., statistical data of wind speed on the geographic area). In some implementations, the availability of a grid cell is indicated in the “Label” column in Table 1. A geographical area is suitable for wind turbine installation if and only if an applied label is set to “available” (or an equivalent). A label of “prohibited” (or the equivalent) is used in the case of, for example, a lake, buildings, livestock, and so on (i.e., prohibited areas) and indicates that no turbine can be placed within in it. A prohibited area affects the process of generating initial solutions, crossover, mutation, and selection in GA.

In some implementations, the technical parameters of a wind turbine used for computational purposes can be stored in the database 302 in a separate wind turbine information table (Table 2) storing data similar to:

TABLE 2

| Column Name | Description |
|---|---|
| Rotor Diameter | Diameter of the wind rotor. |
| Hub Height | Height of the hub. |
| Cut-in Speed | A low threshold of wind speed for blades to spin and |
| | generate power. |
| Cut-out Speed | A high threshold of wind speed for blades to shut down |
| | to avoid damage. |
| Nominal Power | When the wind reaches a nominal speed, output power is |
| | constant. |
| Thrust | A constant value The proportion of energy captured |
| Coefficient | when the wind passes through the blades of the turbine. |

In the example wind turbine information table, several parameters of the wind turbine are provided. Of particular note are rotor diameter and hub height values that are useful for wake effect calculations related to the particular wind turbine 102.

In some implementations, necessary parameters for cost evaluation and algorithm tuning can be stored in the database 302 in a separate algorithm parameter table (Table 3) storing data similar to:

TABLE 3

| Column Name | Description |
|---|---|
| CMP-1 | λ, used in cost model. |
| CMP-2 | μ, used in cost model. |
| CMP-3 | ρ, used in cost model. |
| CMP-4 | ε, used in cost model. |
| ALGO-1 | β, used in the crossover operation of genetic algorithm. |

Output Data

In typical implementations, output data is also stored in a database 302. The output data can be visualized through display device 320 (e.g., computing display, projector, etc.) using graphical user interface (GUI) 322 (e.g., a visual/icon-driven interface, etc.). For example, GUI 322 can show positions of wind turbines in the wind farm 100. Since a lattice partition is used for processing, a lattice position can be provided instead of an actual geographical location on the map. GUI 322 can also contain particular user interface designs to show optimization results (e.g., graphic visualization of wind farm layout and/or various dashboards).

In some implementations, the output data describing a wind farm 200 layout can be stored in the database 302 in a separate output data table (Table 4) storing data similar to:

TABLE 4

| Column Name | Description |
|---|---|
| Wind Turbine ID | ID of wind turbine. |
| Location | Coordinate of lattice where a wind turbine is installed. |
| Output Power | Output power of the wind turbine. |
| Total Output | Total output power from the wind farm. |
| Total Cost | Total cost of the wind farm. |

In some implementations, the computing handler 304 is a computing module managing output computing and cost computing functions. In these implementations, an output computing 306 module includes a theoretical output evaluation 307a module for evaluating a layout of wind farm and its theoretical value without considering wake effects among wind turbines and an interactive effect evaluation 307b module to evaluate wake effect influence among wind turbines. A cost computing 308 module is used to calculate cost(s) for wind farm and manages main cost 309a and miscellaneous cost 309b functions. The main cost 309a module determines/contains the cost of wind turbines while the miscellaneous cost 309b module determines/contains miscellaneous costs (e.g., road construction costs, installation costs, transportation costs, and/or the like).

In some implementations, the optimization handler 310 is computing module to cope with layout optimization by using a GA and managing chromosome generator 312, fitness evaluator 314, genetic operator 316, and chromosome selection and update operator 316 functions. In these implementations, the chromosome generator 312 module encodes potential solutions as a chromosome. The fitness evaluator 314 module evaluates each chromosome with help of an included chromosome decode 315a module and a fitness function evaluation 315b module (e.g., using the objective function in the description of FIG. 2B). In typical implementations, the chromosome decode 315a module is used to transform a ‘0’ and ‘1’ filled array representation of a chromosome into an actual wind turbine layout (i.e., a set of wind turbine locations). The genetic operator 316 module includes a crossover 317a module and a mutation 317b module used to randomly exchange or change elements of chromosomes. The chromosome selection and update operator 318 module is used to select chromosomes and/or update chromosomes to select higher performance chromosomes as parents to generate children and update a population for a next generation. With respect to selection and update criteria, here ‘select and update’ typically mean to select a set of chromosomes which have highest fitness scores from a population (e.g., a set of chromosomes) after crossovers and then updating the population by removing all of other unselected chromosomes.

Objective Function Calculations

In typical implementations, the objective function calculations use results of the above-described output computing and cost computing functions.

Electricity Production

With respect to calculation of power output, there are several existing methods to model expected annual electricity production value in the industry, such as a Jensen model and a CFD (computational fluid dynamics) model. For the purposes of this disclosure, the Jensen model is used and assumes that wind turbines are placed enough far from others, and computes the wake effect (i.e., the wind speed loss due to upwind turbines) by a linear equation, such that the overall electricity production is:

$${E}_{total} ( ) = {\sum }_{d} {\sum }_{s} P ( s , d ) \cdot {\sum }_{i = 1}^{N} E ( s \cdot ( 1 - \sqrt{{\sum }_{j ∈ {W}_{d} ( i )} {v}_{ji}^{2}} ) )$$

where E(s) denotes the electricity that can be produced by a wind turbine for a given wind speed, W_{d}(i) denotes all the affected downstream wind turbines due to wake effects generated by wind turbine i, and vⱼᵢ denotes the velocity deficit (i.e. wind speed loss) of wind turbine j caused by wind turbine i.

Wake Effect Calculation

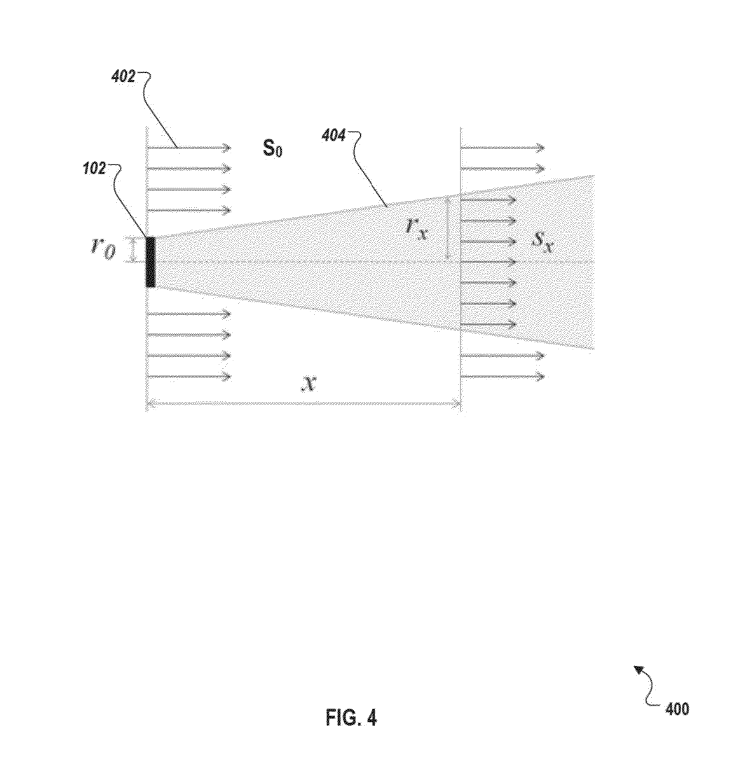

FIG. 4 illustrates an example of a wake effect 400 according to an implementation. In FIG. 4, the arrows (pointing left to right representing direction of wind movement) represent a wind speed (S₀), the rectangle on the left represents a wind turbine (i) 102, and the shaded area represents the wake cone 404. The wind blows from left to right at speed s₀ and hits wind turbine i 102 whose rotor radius is r₀. At a distance x downwind, the wind speed becomes sₓ and the wake radius becomes, for example:

rₓ=α·x+r₀,

where α determines how quickly the wake expands. Every downstream wind turbine 102 in the affected area of the wake effect should be included in W_{d}(i).

The velocity deficit value of a wind turbine j affected by the wake of wind turbine i 102 is determined by:

$${v}_{ji} = \frac{2 \cdot A}{1 + α \cdot {( \frac{{x}_{ij}}{{r}_{d}} )}^{2}}$$

where A is called an axial induction factor and r_{d} is called downstream rotor radius. The above-mentioned three intermediate variables α, A, and r_{d} are, respectively, determined by:

$$α = \frac{0.5}{ln \frac{z}{{z}_{0}}} , a = 0.5 \cdot ( 1 - \sqrt{1 - {C}_{T}} ) , and {r}_{d} = {r}_{0} \cdot \sqrt{\frac{1 - A}{1 - 2 \cdot A}}$$

where z is the hub height of the wind turbine, z₀ is a constant called surface roughness, and C_{T} is a constant called trust coefficient. In typical implementations, these three values are predefined parameters.

Cost Model

With respect to cost models, two different cost models may be used. The first cost model is relatively simpler—it is just a function of the number of turbines, for example:

Cₜₒₜₐₗ( [symbol] )=N·(λ+(1−λ)·e^{-μ·N}^{²})

where λ and μ are two empirically predefined parameters. The value of this function can be efficiently calculated, therefore this cost model is typically used for fast calculations of early generations of the genetic algorithm.

In contrast, when populations of genes (i.e., individuals or potential solutions) become steady, a more accurate but more computationally-expensive second cost model is used. In the second cost model, total cost consists of two components: 1) cost of installation, which is similar to the previous model, and 2) a cost of building roads at the wind farm 100 site, for example:

Cₜₒₜₐₗ( [symbol] )=N·(λ+(1−λ)·e^{-ρ·N}^{²})+C_{roads}( [symbol] )

where ρ is another empirically predefined parameter. The cost of building roads is considered proportional to the total length of roads that should be built to connect each of the wind turbines 102. Given a windy site and a possible wind farm layout, the cost of generating a set of new roads, denoted by [symbol] , (generation discussed below) where the road building cost is minimized is given by:

$${C}_{roads} ( ) = ɛ \cdot Length ( r )$$

Road Planning

In typical implementations, road planning for a given wind farm layout is a sub-problem of the wind farm optimization problem. Given a layout plan of wind turbines 102 in a windy site, a road network is calculated that can:

1) Connect all wind turbines,

2) Use as many existing roads as possible,

3) Avoid going across any prohibited area, and

4) Minimize overall building cost

In typical implementations, road planning includes three steps:

1. new point sampling,

2. network generation, and

3. network optimization.

Road Planning—New Point Sampling

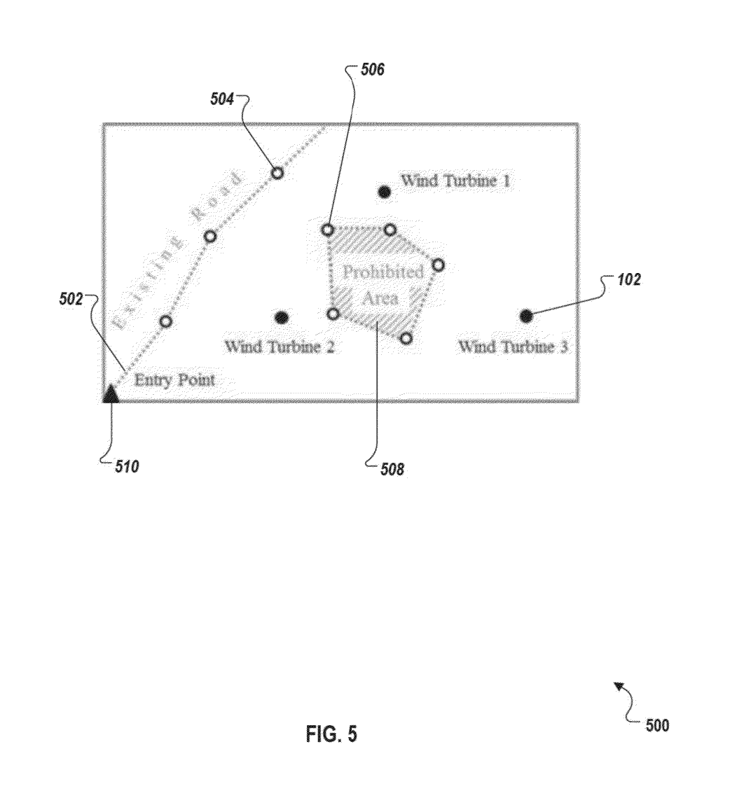

FIG. 5 is an illustration of an example windy site 500 according to an implementation. For each existing road 502 in [symbol] , points 504 are sampled uniformly along the road 502in a given interval δ (vertices of polygons and road lines are typically also included in the sample set). These points 504 are candidate junction points of new roads and existing roads, and provide an opportunity to use an existing road segment when planning a final road network. Similarly, sample points 506 are used in the same manner along an edge of each prohibited area 508. If a direct connecting road between two wind turbines 102 (e.g., between wind turbine 1 and wind turbine 2) is laid across a prohibited area, the sample points 506 can assist in rerouting the road outside the area.

A set of new points is thus obtained in the windy site, denoted by [symbol] . In practice, the sampling interval δ can be set to and value (e.g., a relatively finer granularity, such as 100 m). In FIG. 5, the windy site 500 includes one prohibited area 508, one existing road 502, and three wind turbines 102 (wind turbines 1, 2, and 3). The entry point 510 to the windy site 500 is represented by a triangle.

Road Planning—Network Generation

A planar graph [symbol] is generated, where [symbol] is the set of vertices and E is the set of all possible edges. Here p₀ denotes a predefined entry point 510 on the boundary of the windy site 500, from where construction vehicles can get into the windy site 500. In this way, a possible road network can be obtained for the windy site 500, although its building cost is extremely high. To generate such a planar graph, in some implementations, a Delaunay triangulation is generated. A Delaunay triangulation for a set of points in a plane is a triangulation such that no point in the set is inside a circumcircle of any triangle and maximize the minimum angle of all the angles of the triangles in the triangulation and tend to avoid skinny triangles. For the point set [symbol] , the Delaunay triangulation is generated, in some implementations, by converting the point set's Voronoi diagram using the well-known Fortune's algorithm to its dual graph, and then adding all edges corresponding to existing roads to the graph and removing those edges that lay across prohibited areas. In other implementations, other methods of generating a planar graph can be used and are considered to be within the scope of this disclosure.

Table 5 illustrates an example of a network generation method according to an implementation:

Function GeneratePlanarGraph (V):
% Input: V—Set of points
% Output: G—Planar graph
Generate the Voronoi diagram D of V using Fortune's algorithm.
Convert D to its dual graph G by connecting each pair of points whose corresponding Voronoi cells are adjacent.
ForEach existing road in the windy site:
   Connect each of sampled points along the road, and add all edges to G.
ForEach edge in G:
   If this edge lays across a prohibited area:
      Remove this edge from G.
Return G.

### Table 5

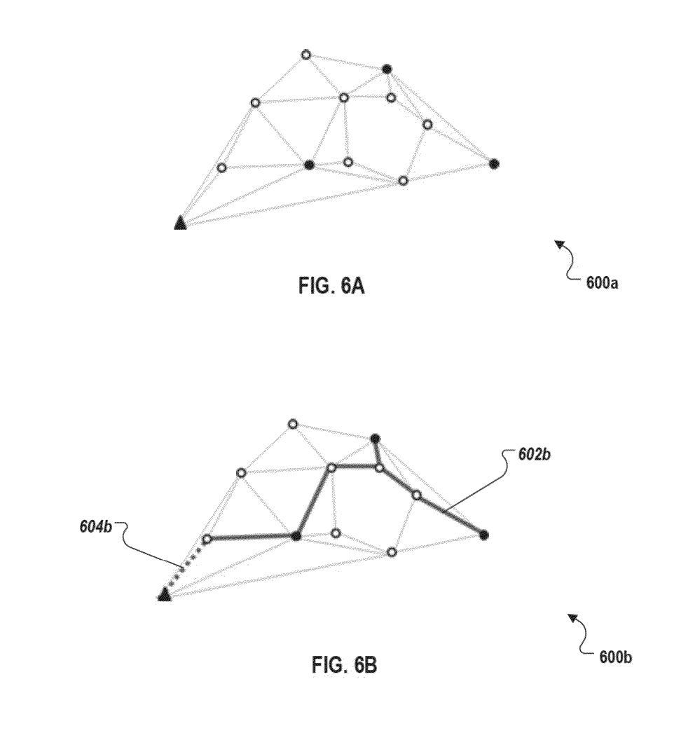

FIG. 6A illustrates an example of a generated planar graph 600a (i.e., a road network, corresponding to elements of the windy site 500 illustrated in FIG. 5) according to an implementation.

Road Planning—Network Optimization

After Network Optimization, a connected sub-graph [symbol] ′ in [symbol] remains, where all the points of wind turbines 102 and the entry point 510 are included, while the sum of edge lengths is minimized. This task is equivalent to finding the minimum Steiner tree [symbol] in the graph [symbol] , where all points in [symbol] are Steiner points (i.e., they are not required to be included in [symbol] ) and all points in [symbol] ∪{p₀} are terminals (i.e., they are required to be included in [symbol] ).

In typical implementations, the length of an edge is defined as follows:

$$Length ( e ) = \{ \begin{matrix}Distance of two end points , & if e is not a part of an existing road \\ 0 & if e is a part of an existing road\end{matrix}$$

In typical implementations, the algorithm of finding the minimum Steiner tree in [symbol] can be represented as follows:

Function FindMinimumSteinerTree (S, T, E):
% Input: S—Steiner points
% T—Terminals
% E—Edges
% Output: M—Minimum Steiner tree
Start with a initial tree M consisting of one terminal in T.
While M does not span all terminals:
   Select a terminal x not in M that is closest to a vertex in M.
   Add to M the shortest path that connects x with M.
Return M.

After calculation of a minimum Steiner tree, each edge is added in the calculated Steiner tree to set [symbol] if it is not a part of an existing road.

FIG. 6B illustrates an example of a calculated [symbol] 600b given the road network shown in FIG. 6A according to an implementation. In FIG. 6B, thick edges (e.g., 602b) denote roads to build, and the dashed edge (e.g., 604b) denotes an existing road segment that is included in the road network. As the above is an approximation algorithm of solving the NP-hard minimum Steiner tree problem, it can be proved that its approximation ratio is at most 2. IN addition, the optimized road network found on a planar graph will be not as good as the one found in a complete graph. However, planarization can greatly reduce the computational cost of the entire algorithm, and its result can be proved to be nearly 2.5 times worse in an extreme case. Therefore, the described method is a tradeoff for practicality in typical instances.

Optimization Algorithm

GA is used to optimize a wind farm layout to simultaneously maximize power output and minimize cost. GA is a method for solving optimization problems based on a natural selection process that mimics biological evolution (a genetic algorithm). The genetic algorithm repeatedly modifies a population of individual solutions. At each step, the genetic algorithm randomly selects individuals from the current population and uses them as parents to produce children for the next generation. Over successive generations, a population “evolves” toward an optimal solution.

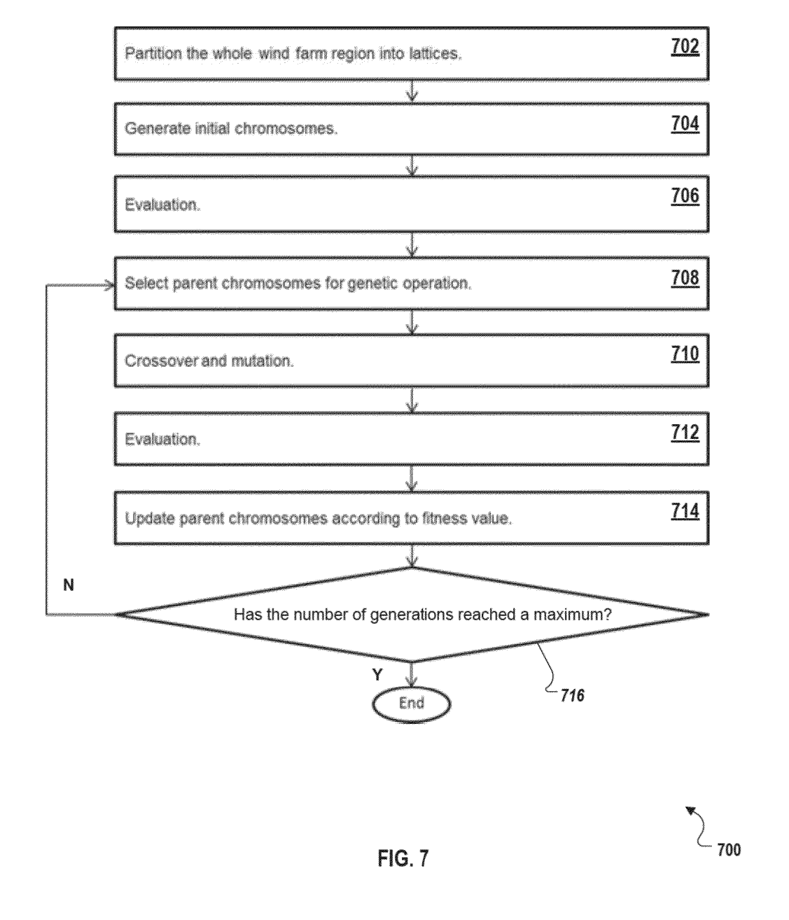

FIG. 7 is a flow chart illustrating a genetic algorithm 700 for finding a best location scheme for a set of interactional objects in a constrained geographical area according to an implementation. FIG. 7 reflects modifications made to known GA algorithms. Modifications have been made in at least initialization (e.g., not all the chromosomes are generated randomly; some chromosomes are generated by using greedy method) and in fitness evaluation (e.g., at the beginning the cost is evaluated by means of a simplified empirical formula, which is only relative to the number of turbines; when the fitness (e.g., performed by the fitness function evaluation 315b module) is larger than some pre-defined threshold, a more accurate cost evaluation method is alternatively implemented as described above).

For clarity of presentation, the description that follows generally describes method 700 in the context of FIGS. 1, 2A-2B, 3-5, 6A-6B, 8-9, 10A-10B, and 11. However, it will be understood that method 700 may be performed, for example, by any other suitable system, environment, software, and hardware, or a combination of systems, environments, software, and hardware as appropriate. In some implementations, various steps of method 700 can be run in parallel, in combination, in loops, and/or in any order.

At 702, an entire geographical area is first partitioned into lattices (e.g., 50×50 lattices in a 25 km² region) where a wind turbine could be placed. From 702, method 700 proceeds to 704.

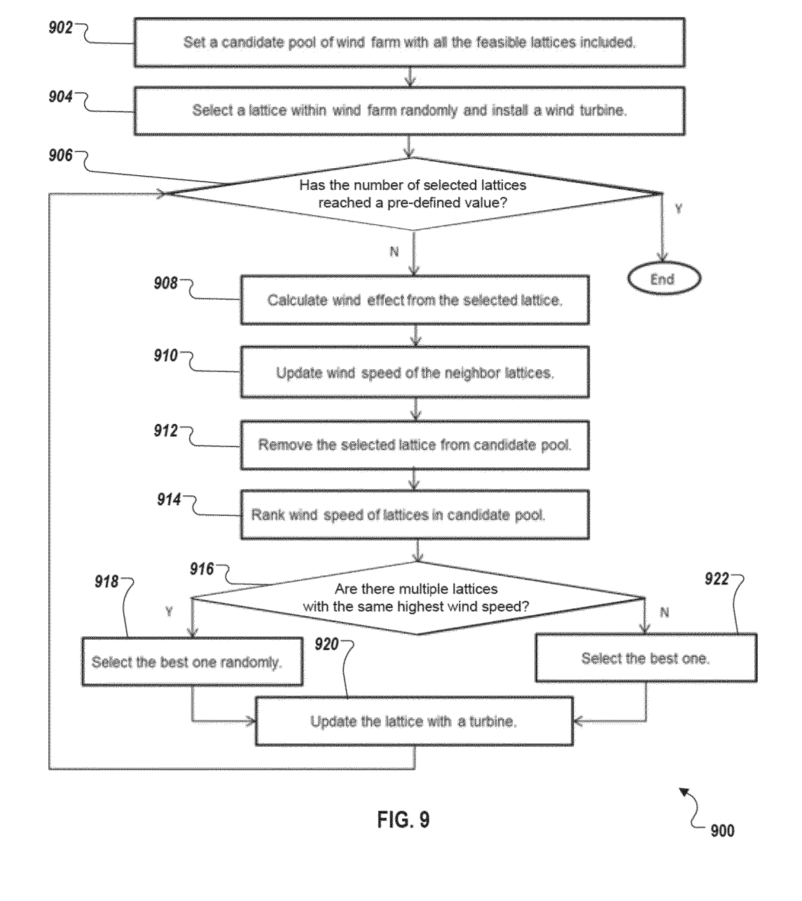

At 704, initial chromosomes are generated (e.g., randomly—see FIG. 9 for an example of a greedy method for generating chromosomes). In some implementations, a wind turbine 102 can be initially allocated in the center of every lattice. If any prohibited area is located in a lattice, the lattice (gene) should be eliminated from the chromosome to avoid infeasible solution. In some implementations, a wind turbine could be situated within a lattice to avoid a prohibited area if possible (i.e., not in the center).

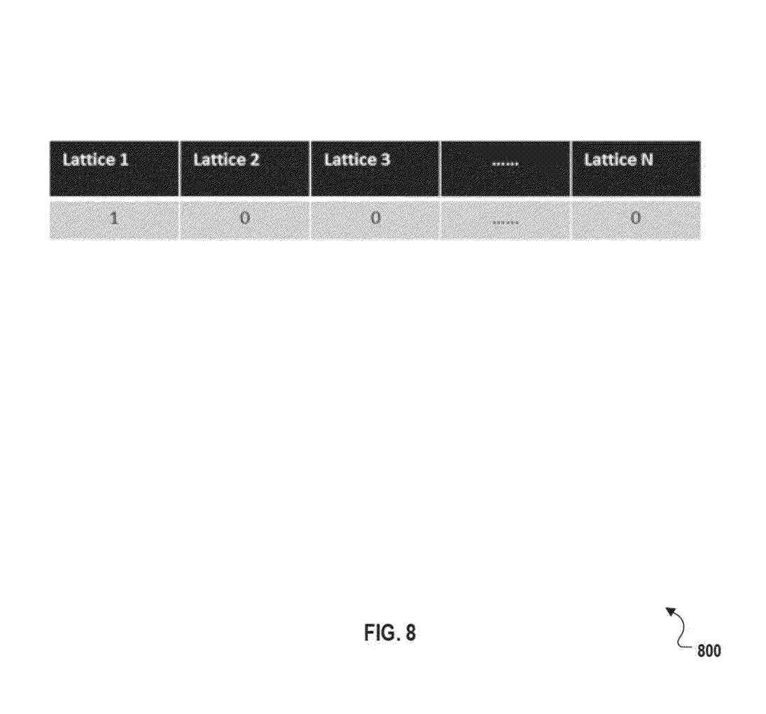

Turning to FIG. 8, FIG. 8 illustrates an example of an encoded chromosome 800 according to an implementation. In FIG. 8, a binary series is used to represent a layout of turbines. For example, in the illustrated chromosome 800, a “1” denotes a turbine is allocated (e.g., in lattice 1) while a “0” denotes no turbine is set in the associated lattice (e.g., lattices 2, 3, . . . , and N). Here, one or more of lattices 2, 3, or N could be associated with prohibited areas. Each chromosome 800 represents one solution to the layout optimization problem. Returning to FIG. 7, from 704, method 700 proceeds to 706.

At 706, each solution is evaluated for fitness. For example, the objective function defined with respect to FIG. 2B above is set as a fitness function for evaluation, where a fitness score of a gene reflects the “goodness” of a solution. During the process of GA, only genes having adequate fitness scores can survive to future rounds of iterations. In this way after several iterations only the best genes, or best solutions, are left. From the description of FIG. 2B above:

$$Fitness = \frac{{E}_{total} ( )}{{C}_{total} ( )}$$

From 706, method 700 proceeds to 708.

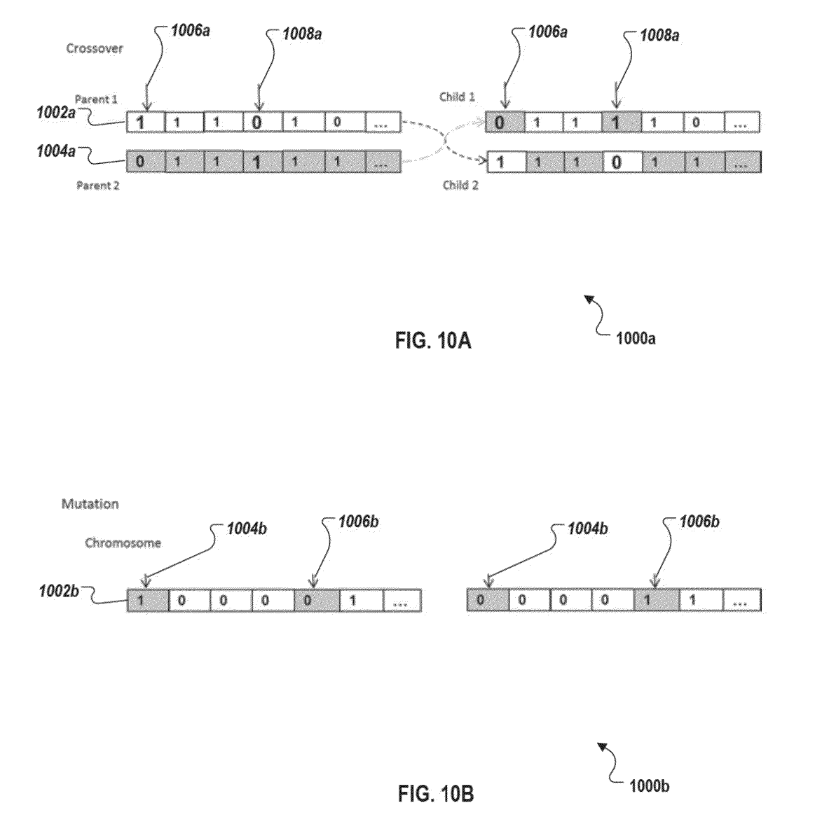

At 708, the highest valued solutions in terms of “fitness” are selected as parent chromosomes for crossover and mutation operations to generate child chromosomes (refer to FIGS. 10A & 10B below). From 708, method 700 proceeds to 710.

At 710, crossover and mutation operations are performed using the selected parent chromosomes from 708. From 710, method 700 proceeds to 712.

At 712, the children and evaluated for “fitness” (e.g., see objective function with respect to FIG. 2B). From 712, method 700 proceeds to 714.

At 714, the parent chromosomes from 708 are updated using the highest valued solutions determined from 712. Here good solutions are selected to replace their parents. In this way, a new (better) generation is formed from which an eventual solution is selected. From 714, method 700 proceeds to 716.

At 716, a determination is made whether a maximum number of generations has been reached. In some implementations, a maximum number of generations is a pre-defined parameter and can depend upon on specific applications. For example, in solving a wind farm layout optimization problem, the maximum number of generations can be set to 1000 or some other value. In other implementations, this value can be dynamically generated. If the maximum number of generations has not been reached, method 700 proceeds to 708. If the maximum value has been reached, method 700 ends.

FIG. 9 is a flow chart illustrating an alternative example genetic algorithm 900 to finding a best location scheme for a set of interactional objects in a constrained geographical area according to an implementation. Note that FIG. 9 generates initial chromosomes using a greedy method algorithm (while FIG. 7, as described above, uses a random method). In this way, different solutions can be generated (random as in FIG. 7 vs. greedy as in FIG. 9) and an optimum solution(s) can be selected from both types of solutions.

For clarity of presentation, the description that follows generally describes method 900 in the context of FIGS. 1, 2A-2B, 3-5, 6A-6B, 7-8, 10A-10B, and 11. However, it will be understood that method 900 may be performed, for example, by any other suitable system, environment, software, and hardware, or a combination of systems, environments, software, and hardware as appropriate. In some implementations, various steps of method 900 can be run in parallel, in combination, in loops, and/or in any order.

At 902, a candidate wind farm is selected and partitioned into lattices (e.g., 50×50 lattices in a 25 km² region) where a wind turbine could be placed. From 902, method 900 proceeds to 904.

At 904, a lattice is selected at random and a wind turbine installed. If any prohibited area is located in a lattice, the lattice (gene) is typically eliminated from the chromosome to avoid infeasible solution. For example, in some implementations, if a prohibited area covers the center of a particular lattice cell, then no turbine can be placed in this cell. In other implementations, a wind turbine could be situated precisely within a lattice to avoid a prohibited area if possible (e.g., move the turbine to the side of a lattice cell to avoid a prohibited area encroaching into the lattice cell). From 904, method 900 proceeds to 906.

At 906, a determination is made whether a number of turbines has reached a threshold value. For example, in some implementations, the threshold value can be predefined and set to 33 or some other value. In other implementations, this value can be dynamically generated. If the number of turbines has not reached the threshold level, method 900 proceeds to 908. If so, method 900 ends.

At 908, a wind effect calculation is performed on the selected lattice. From 908, method 900 proceeds to 910.

At 910, wind speeds of neighboring lattices are updated based on the calculated wind effect calculation of 908. From 910, method 900 proceeds to 912.

At 912, the selected lattice is removed from the candidate pool. From 912, method 900 proceeds to 904.

At 914, the wind speed(s) associated with the remaining lattices in the candidate pool are ranked. From 914, method 900 proceeds to 916.

At 916, a determination is made whether there are multiple lattices with the same highest wind speed. If YES, method 900 proceeds to 918. If NO, method 900 proceeds to 922.

At 918, a “best” lattice is selected from the multiple lattices with the same highest wind speed. From 918, method 900 proceeds to 920.

At 920, the selected “best” lattice is updated with a wind turbine. From 920, method 900 proceeds back to 906.

At 922, a “best” lattice is selected from the multiple lattices with the same highest wind speed using available criteria. Typically, the intrinsic goodness (or “best”) lattice is predefined by domain experts and is an input parameter). In other implementations, it can be possible for different factors (e.g., location, output power, total output, total cost, and/or other factors) to be used to determine which lattice is considered the “best” (e.g., by a dynamic calculation, possibly including the goodness parameter predefined by the domain experts as part of the calculation). From 922, method 900 proceeds to 920 where the selected “best” lattice is updated with a wind turbine. From 920, method 900 proceeds back to 906.

Crossover and Mutation

In some implementations, it is possible to move a turbine assigned to a particular lattice to a different lattice using one or more genetic operators introduced into the GA.

FIG. 10A illustrates an example of a crossover operation according to an implementation. The purpose of crossover operation is to generate new chromosomes, so that the ‘best’ chromosome can eventually be determined. However, generating new chromosomes by random is not a good choice because it is at least computationally time consuming. In order to increase efficiency, two existing chromosomes are allowed to crossover to generate one or two new chromosomes (e.g., similar to merging of two DNA strands). The key of this purposed crossover method is that the two child chromosomes should be as similar to one of their parents as possible, so that the good characteristics of their parents can be derived. In this case, a (swap 2*beta*(number of turbines) pairs of bits of the parents) is typically performed. In this way, two new chromosomes are generated, and they are both similar to their parents. Note that attributes such as prohibited areas are taken into account in the crossover operation so that a wind turbine is not, for example, switched into a prohibited area.

As shown in FIG. 10A, two parent chromosomes parent 1 and parent 2 (1002a and 1004a, respectively) are selected from available chromosomes. In some implementations, a parent chromosome may move a turbine due to a pattern (a layout unit) that exists in another parent chromosome. For example, in FIG. 10A, in the first lattice (lattice 1 1006a), a turbine is allocated in Parent 1 while not allocated in Parent 2; the opposite situation is found in the fourth lattice (lattice 4 1008a). This forms a pair of changeable lattices where turbines can change position according to information associated with the other chromosome. This operation can guarantee the number of turbines in the chromosomes is fixed. Generally, a crossover can be implemented using the following steps:
1. Find all pairs of changeable lattices (as illustrated in FIG. 10A), e.g., n pairs exist.
2. Determine how many turbines wish to change their positions using a parameter (beta):

β(0<β<1)
i.e., the number of turbines to be moved equals to ┌N·β┐. In some implementations, beta is a customer-defined parameter. The larger the value of beta, the more turbines will be randomly moved in a mutation process of a particular solution, and the faster the convergence state of GA will be achieved. Note that, in typical implementations, “wish to change” means the degree of similarity between parents and children. For example, if there are more turbines that “wish” to change their positions, more pairs of bits will be swapped in the process of crossover. Therefore, child chromosomes are less similar to their parents. In this case, there is a higher possibility of finding the best chromosome more quickly.
3. Randomly select pairs of changeable genes and exchange their values.

FIG. 10B illustrates an example of a mutation operation according to an implementation. The purpose of the mutation operation is similar to that of the crossover operation. The difference is that, crossover operations need two chromosomes to be performed while the mutation operation needs only one. The reason for introducing mutation into the algorithm is to prevent the algorithm being trapped in a poor situation in which all parents and all children are of low quality. Mutation gives the algorithm the opportunity to create unexpected chromosomes which may be much better than those in a current population. As shown in FIG. 10B, a wind turbine is moved randomly within a chromosome 1002b from one lattice to another (here from the first lattice 1004b to the fifth lattice 1006b).

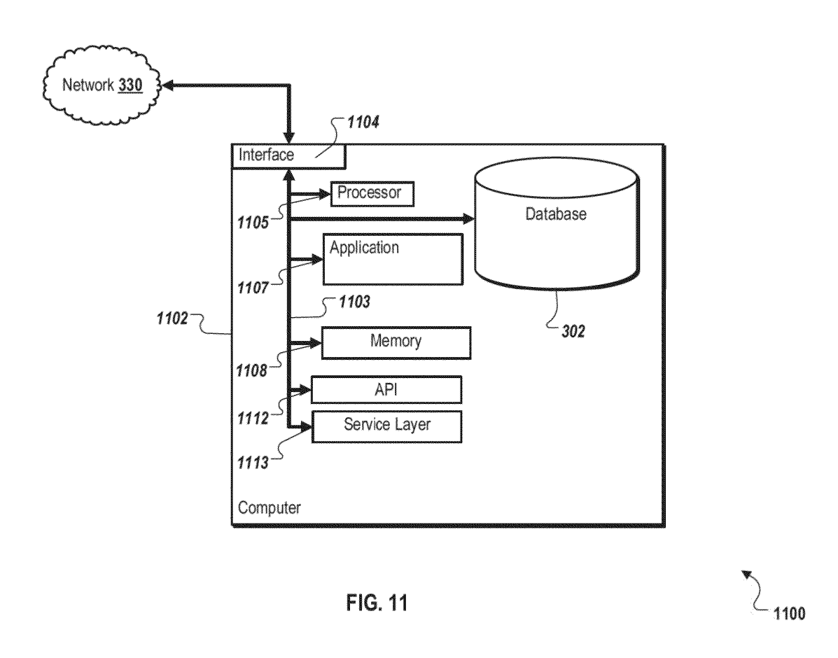

FIG. 11 is a block diagram 1100 of an exemplary computer 1102 used in the EDCS 300 of FIG. 3 according to an implementation. The illustrated computer 1102 is typically of a mobile design, but is intended to encompass any computing device such as a server, desktop computer, laptop/notebook computer, wireless data port, smart phone, personal data assistant (PDA), tablet computing device, one or more processors within these devices, or any other suitable processing device, including both physical and/or virtual instances of the computing device. Additionally, the computer 1102 may comprise a computer that includes an input device, such as a keypad, keyboard, touch screen, or other device that can accept user information, and an output device that conveys information associated with the operation of the computer 1102, including digital data, visual and/or audio information, or a GUI.

The computer 1102 can process for/serve as any component of the EDCS 300 (whether or not illustrated) or other system, component, etc. describe in this disclosure. The illustrated computer 1102 is communicably coupled with a network 330. In some implementations, one or more components of the computer 1102 may be configured to operate within a cloud-computing-based environment.

At a high level, the computer 1102 is an electronic computing device operable to receive, transmit, process, store, or manage data and information associated with the EDCS 300. According to some implementations, the computer 1102 may also include or be communicably coupled with a cloud-computing server, application server, e-mail server, web server, caching server, streaming data server, business intelligence (BI) server, and/or other server.

The computer 1102 can receive requests over network 330 from a client application (e.g., a mobile UI and/or web-based application UI executing on another computer 1102 in use by a customer) and responding to the received requests by processing the said requests in an appropriate software application. In addition, requests may also be sent to the computer 1102 from internal users (e.g., from a command console or by other appropriate access method), external or third-parties, other automated applications, as well as any other appropriate entities, individuals, systems, or computers.

Each of the components of the computer 1102 can communicate using a system bus 1103. In some implementations, any and/or all the components of the computer 1102, both hardware and/or software, may interface with each other and/or the interface 1104 over the system bus 1103 using an API 1112 and/or a service layer 1113. The API 1112 may include specifications for routines, data structures, and object classes. The API 1112 may be either computer-language independent or dependent and refer to a complete interface, a single function, or even a set of APIs. The service layer 1113 provides software services to the computer 1102 and/or the EDCS 300. The functionality of the computer 1102 may be accessible for all service consumers using this service layer. Software services, such as those provided by the service layer 1113, provide reusable, defined business functionalities through a defined interface. For example, the interface may be software written in JAVA, C++, or other suitable language providing data in extensible markup language (XML) format or other suitable format. While illustrated as an integrated component of the computer 1102, alternative implementations may illustrate the API 1112 and/or the service layer 1113 as stand-alone components in relation to other components of the computer 1102 and/or EDCS 300. Moreover, any or all parts of the API 1112 and/or the service layer 1113 may be implemented as child or sub-modules of another software module, enterprise application, or hardware module without departing from the scope of this disclosure.

The computer 1102 includes an interface 1104. Although illustrated as a single interface 1104 in FIG. 11, two or more interfaces 1104 may be used according to particular needs, desires, or particular implementations of the computer 1102 and/or EDCS 300. The interface 1104 is used by the computer 1102 for communicating with other systems in a distributed environment—including within the EDCS 300—connected to the network 330 (whether illustrated or not). Generally, the interface 1104 comprises logic encoded in software and/or hardware in a suitable combination and operable to communicate with the network 330. More specifically, the interface 1104 may comprise software supporting one or more communication protocols associated with communications such that the network 330 or interface's hardware is operable to communicate physical signals within and outside of the illustrated EDCS 300.

The computer 1102 includes a processor 1105. Although illustrated as a single processor 1105 in FIG. 11, two or more processors may be used according to particular needs, desires, or particular implementations of the computer 1102 and/or the EDCS 300. Generally, the processor 1105 executes instructions and manipulates data to perform the operations of the computer 1102. Specifically, the processor 1105 executes the functionality required for finding a best location scheme for a set of interactional objects in a constrained geographical area.

The computer 1102 also includes a database 302 and memory 1108 that hold data for the computer 1102 and/or other components of the EDCS 300. Although illustrated as a single database 302 and memory 1108 in FIG. 11, two or more databases 302 and memories 1108 may be used according to particular needs, desires, or particular implementations of the computer 1102 and/or the EDCS 300. While database 302 and memory 1108 are illustrated as integral components of the computer 1102, in alternative implementations, the database 302 and memory 1108 can be external to the computer 1102 and/or the EDCS 300. In some implementations, the database can be a conventional database or an in-memory database, or a mix of both. In some implementations, the database 302 and memory 1108 can be combined into one component.

The application 1107 is an algorithmic software engine providing functionality according to particular needs, desires, or particular implementations of the computer 1102 and/or the EDCS 300, particularly with respect to functionalities required for finding a best location scheme for a set of interactional objects in a constrained geographical area. For example, application 1107 can serve as any component of the EDCS 300 (whether or not illustrated). Further, although illustrated as a single application 1107, the application 1107 may be implemented as multiple applications 1107 on the computer 1102. In addition, although illustrated as integral to the computer 1102, in alternative implementations, the application 1107 can be external to the computer 1102 and/or the EDCS 300.

There may be any number of computers 1102 associated with, or external to, the EDCS 300 and communicating over network 330. Further, the term “client,” “user,” and other appropriate terminology may be used interchangeably as appropriate without departing from the scope of this disclosure. Moreover, this disclosure contemplates that many users may use one computer 1102, or that one user may use multiple computers 1102.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus,” “computer,” and/or “electronic computer device” (or equivalent as understood by one of ordinary skill in the art) refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/-R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
partitioning, a geographic region representing a wind farm into a plurality of lattices;
generating initial chromosomes, wherein a particular chromosome is a binary series used to represent the presence of a wind turbine in a layout of the plurality of lattices;
evaluating a cost associated with each wind turbine associated with the initial chromosomes;
selecting parent chromosomes for a genetic operation;
evaluating, following the genetic operation, a cost associated with each wind turbine; and
updating the parent chromosomes using a fitness value.

2. The method of claim 1, wherein the genetic operation includes at least one of a crossover or mutation operation.

3. The method of claim 1, comprising determining whether a generated value has met a maximum threshold value.

4. The method of claim 1, comprising:
establishing a candidate pool of feasible lattices associated with a wind farm;
randomly selecting a lattice within the pool of feasible lattices;
installing a wind turbine on the selected lattice;
calculating a wind effect from the selected lattice;
updating wind speed associated with neighboring lattices;
removing the selected lattice from the candidate pool; and
ranking wind speed of lattices in the candidate pool.

5. The method of claim 4, comprising determining whether multiple lattices in the candidate pool have identical largest wind speeds.

6. The method of claim 5, comprising determining and selecting a best lattice from among the multiple lattices in the candidate pool with identical largest wind speeds or selecting at random a best lattice from among the multiple lattices in the candidate pool with identical largest wind speeds.

7. The method of claim 6, comprising updating the selected lattice with a wind turbine.

8. A non-transitory, computer-readable medium storing computer-readable instructions executable by a computer and configured to:
partition, a geographic region representing a wind farm into a plurality of lattices;
generate initial chromosomes, wherein a particular chromosome is a binary series used to represent the presence of a wind turbine in a layout of the plurality of lattices;
evaluate a cost associated with each wind turbine associated with the initial chromosomes;
select parent chromosomes for a genetic operation;
evaluate, following the genetic operation, a cost associated with each wind turbine; and
update the parent chromosomes using a fitness value.

9. The medium of claim 8, wherein the genetic operation includes at least one of a crossover or mutation operation.

10. The medium of claim 8, configured to determine whether a generated value has met a maximum threshold value.

11. The medium of claim 8, configured to:
establish a candidate pool of feasible lattices associated with a wind farm;
randomly select a lattice within the pool of feasible lattices;
install a wind turbine on the selected lattice;
calculate a wind effect from the selected lattice;
update wind speed associated with neighboring lattices;
remove the selected lattice from the candidate pool; and
rank wind speed of lattices in the candidate pool.

12. The medium of claim 11, configured to determine whether multiple lattices in the candidate pool have identical largest wind speeds.

13. The medium of claim 12, configured to determine and select a best lattice from among the multiple lattices in the candidate pool with identical largest wind speeds or to select at random a best lattice from among the multiple lattices in the candidate pool with identical largest wind speeds.

14. The medium of claim 13, configured to update the selected lattice with a wind turbine.

15. A system, comprising:
a memory;
at least one hardware processor interoperably coupled with the memory and configured to:
partition, a geographic region representing a wind farm into a plurality of lattices;
generate initial chromosomes, wherein a particular chromosome is a binary series used to represent the presence of a wind turbine in a layout of the plurality of lattices;
evaluate a cost associated with each wind turbine associated with the initial chromosomes;
select parent chromosomes for a genetic operation;
evaluate, following the genetic operation, a cost associated with each wind turbine; and
update the parent chromosomes using a fitness value.

16. The system of claim 15, wherein the genetic operation includes at least one of a crossover or mutation operation.

17. The system of claim 15, configured to determine whether a generated value has met a maximum threshold value.

18. The system of claim 15, configured to:
establish a candidate pool of feasible lattices associated with a wind farm;
randomly select a lattice within the pool of feasible lattices;
install a wind turbine on the selected lattice;
calculate a wind effect from the selected lattice;
update wind speed associated with neighboring lattices;
remove the selected lattice from the candidate pool; and
rank wind speed of lattices in the candidate pool.

19. The system of claim 18, configured to determine whether multiple lattices in the candidate pool have identical largest wind speeds.

20. The system of claim 19, configured to:
determine and select a best lattice from among the multiple lattices in the candidate pool with identical largest wind speeds or to select at random a best lattice from among the multiple lattices in the candidate pool with identical largest wind speeds; and
update the selected lattice with a wind turbine.
